(19) United States
(12) Patent Application Publication
(10) Pub. No.: US 2014/0285915 A1
(43) Pub. Date: Sep. 25, 2014

(54) DISK STORAGE APPARATUS, DATA REPRODUCTION APPARATUS AND DATA REPRODUCTION METHOD

(71) Applicant: KABUSHIKI KAISHA TOSHIBA, Tokyo (JP)

(72) Inventor: Nobuhiro Maeto, Yokohama-shi (JP)

(73) Assignee: KABUSHIKI KAISHA TOSHIBA, Tokyo (JP)

(21) Appl. No.: 13/956,610

(22) Filed: Aug. 1, 2013

(30) Foreign Application Priority Data
Mar. 19, 2013 (JP) 2013-056961

(51) Int. Cl. G11B 20/10

(52) U.S. Cl. CPC G11B 20/10046
USPC 360/40

(57) ABSTRACT

According to one embodiment, in a disk storage apparatus, a cancel controller cancels interference on a read target track from adjacent tracks from equalization waveform data obtained by applying waveform equalization processing to a read signal of the read target track based on an interference amount between adjacent tracks. An ITI controller determines whether or not an interference amount for a next read target track exceeds a prescribed value based on the interference amount corresponding to the read target track, and stores, when the interference amount exceeds the prescribed value, the equalization waveform data for the read target track in the memory as cancel data used to cancel interference on the next read target track.

### CROSS-REFERENCE TO RELATED APPLICATIONS

This application is based upon and claims the benefit of priority from Japanese Patent Application No. 2013-056961, filed Mar. 19, 2013, the entire contents of which are incorporated herein by reference.

### FIELD

Embodiments described herein relate generally to a disk storage apparatus, data reproduction apparatus, and data reproduction method.

### BACKGROUND

In recent years, in the field of a disk storage apparatus (also described as a disk drive hereinafter) such as a hard disk drive (HDD), a track density on a disk as a storage medium is increasing since a shingled write magnetic recording (SMR) method or the like is adopted. For this reason, an interval between adjacent tracks is narrowed down, and especially in a read operation mode in which recorded data are sequentially read from continuous tracks, that operation is susceptible to interference of magnetic recording signals of adjacent tracks. Such signal interference between adjacent tracks is often called inter-track interference (ITI).

When a disk drive reproduces recorded data from a read signal from a track, it decodes the recorded data to non-return to zero (NRZ) data for respective sectors and stores the decoded data in a buffer memory (DRAM). When the influence of ITI is serious in this data reproduction mode, reproduction quality, reproduction performance, reproduction characteristics, and the like deteriorate, and reproduction errors are more likely to be occurred. Hence, a signal processing technique which executes ITI cancellation (also abbreviated as ITIC hereinafter) that removes interference components from a read signal read from a track has been developed.

Upon execution of ITIC, equalization waveform data generated from NRZ data of a adjacent track stored in the buffer memory (DRAM) is used. The equalization waveform data is output data (FIR samples) of finite impulse response (FIR) filter data which applies waveform equalization processing to a read signal. That is, ITIC is executed by re-constructing equalization waveform data as a read signal waveform from NRZ data.

However, in practice, a read signal read from the disk includes various non-linear noise components caused by asymmetry and non-linear transition shift (NLTS). For this reason, it is confirmed that a re-constructed read signal waveform and an actual read signal waveform have a difference, thus lowering ITIC precision. In order to improve the ITIC precision, it is desirable to store output data of the FIR filter in the DRAM and to read and use the stored data at the ITIC execution timing.

Note that in a data reproduction mode based on the SMR method, a sequential read operation for continuously reading data from a plurality of tracks is executed. In the sequential read operation, NRZ data of all sectors, which are continuously read from respective tracks, are stored in the DRAM. When output data for all sectors of the FIR filer are to be stored in addition to the NRZ data, a large-capacity DRAM is required, resulting in a use efficiency drop of the DRAM.

### BRIEF DESCRIPTION OF THE DRAWINGS

FIG. 1 is a block diagram for explaining the arrangement of a disk drive according to an embodiment;

FIG. 2 is a block diagram for explaining principal part of a read channel according to the embodiment;

FIG. 3 is a view for explaining an example of SMR according to the embodiment;

FIG. 4 is a table for explaining a correspondence relationship between an ITI amount and DRAM data according to the embodiment; and

FIG. 5 is a flowchart for explaining a data reproduction operation including ITI cancellation according to the embodiment.

### DETAILED DESCRIPTION

In general, according to one embodiment, a disk storage apparatus includes a read controller, a cancel controller, a decoder, a memory, and an ITI controller. The read controller is configured to sequentially read data from adjacent tracks on a disk. The cancel controller is configured to cancel interference on a read target track from adjacent tracks from equalization waveform data obtained by applying waveform equalization processing to a read signal of the read target track, which is read by the read controller, based on an interference amount between adjacent tracks. The decoder is configured to decode data from the equalization waveform data in which the interference is canceled. The memory is configured to store the equalization waveform data for the read target track or the decoded data. The ITI controller is configured to determine whether or not an interference amount for a next read target track exceeds a prescribed value based on the interference amount corresponding to the read target track, and to store, when the interference amount exceeds the prescribed value, the equalization waveform data for the read target track in the memory as cancel data used to cancel interference on the next read target track.

Various embodiments will be described hereinafter with reference to the accompanying drawings.

[Arrangement of Disk Drive]

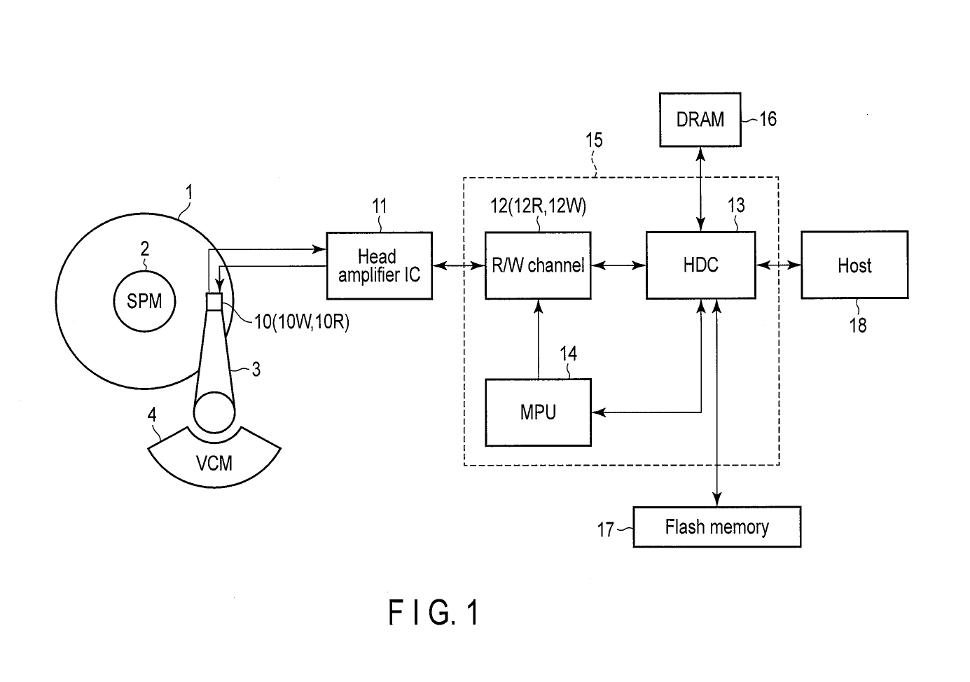

FIG. 1 is a block diagram showing principal part of a disk storage apparatus (disk drive) according to this embodiment.

As shown in FIG. 1, the disk drive roughly includes a head-disk assembly (HDA), a head amplifier integrated circuit (referred to as a head amplifier IC hereinafter) 11, and a system controller 15 including a single-chip integrated circuit.

The HDA includes a disk 1 as a storage medium, a spindle motor (SPM) 2, an arm 3 which mounts a head 10, and a voice coil motor (VCM) 4. The disk 1 is rotated by the spindle motor 2. The arm 3 and VCM 4 configure an actuator. The actuator controls to move the head 10 mounted on the arm 3 to a designated position on the disk 1 upon driving of the VCM 4.

In this embodiment, a plurality of tracks are recorded on the disk 1 in an overlapping state by a shingled write magnetic recording (SMR) operation, as will be described later. The head 10 includes a write head 10W and read head 10R mounted on a slider as a main body. The read head 10R reads data recorded on a track on the disk 1. The write head 10W writes data to the disk 1 by the SMR operation.

The head amplifier IC 11 includes a read amplifier and write driver. The read amplifier amplifies a read signal read by the read head 10R, and transfers the read signal to a read/write (R/W) channel 12. On the other hand, the write driver transfers a write current according to write data output from the R/W channel 12 to the write head 10W.

The system controller 15 includes the R/W channel 12, a hard disk controller (HDC) 13, and a microprocessor (MPU) 14. The R/W channel 12 includes a read channel 12R and write channel 12W. The read channel 12R executes a data reproduction operation for processing a read signal read from a track, and decoding data from the read signal. Also, the read channel 12R has a function of executing ITI cancellation (ITIC) for removing inter-track interference (ITI) as signal interference between adjacent tracks, as will be described later. The write channel 12W executes signal processing of write data.

The HDC 13 controls data transfer between a host 18 and the R/W channel 12. The HDC 13 executes data transfer control by controlling a buffer memory (dynamic random access memory [DRAM]) 16 to temporarily store read data and write data in the DRAM 16. Also, the HDC 13 controls a flash memory 17 to use it as, for example, a cache area for temporarily storing data. The MPU 14 is a main controller of the disk drive, and executes servo control by controlling the VCM 4 to align the head 10. Furthermore, the MPU 14 controls recording/reproduction of data via the R/W channel 12.

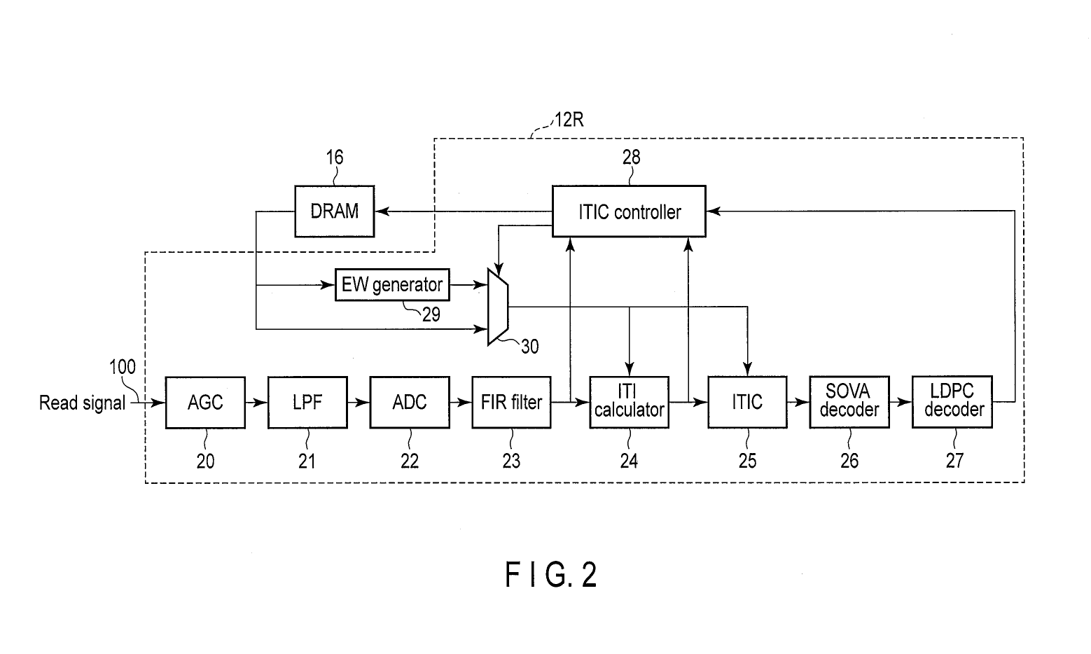

FIG. 2 shows the relationship between principal components of the read channel 12R and the DRAM 16.

As shown in FIG. 2, the read channel 12R includes, as a signal pre-processor, an automatic gain control (AGC) unit 20, low-pass filter (LPF) 21, and analog-to-digital converter (ADC) 22. The AGC unit 20 has an automatic gain control function, and amplifies a read signal 100 transferred from the head amplifier IC 11. The LPF 21 removes noise included in the read signal 100. The ADC 22 converts the read signal 100 into a digital signal.

Furthermore, the read channel 12R includes, as a decoding processor, a finite impulse response (FIR) filter 23, ITI calculator (or ITI estimator) 24, ITI canceller 25, SOVA decoder 26, and LDPC decoder 27.

The FIR filter 23 is a digital filter which applies waveform equalization processing according to a partial response maximum likelihood (PRML) method to the read signal 100, which is converted into a digital signal by the ADC 22. The FIR filter 23 outputs equalization waveform data (FIR output data hereinafter) as an equalization waveform sequence of the read signal 100.

The ITI calculator 24 calculates a cancel coefficient required to execute ITI cancellation (ITIC) based on a correlation coefficient between equalization waveform data of a adjacent track and that of a read target track. The ITI canceller 25 cancels ITI (signal interference or crosstalk) from the adjacent track from the equalization waveform data output from the FIR filter 23 based on the cancel coefficient calculated (estimated) by the ITI calculator 24. That is, the cancel coefficient corresponds to an estimated interference amount α, as will be described later.

The SOVA decoder 26 and LDPC decoder 27 decode recorded data from the equalization waveform data in which ITI is canceled by the ITI canceller 25. The decoders 26 and 27 implement so-called turbo decoding. With this decoding, non-return to zero (NRZ) data is normally decoded.

The SOVA decoder 26 is a Viterbi decoder which executes decoding processing according to a soft-output Viterbi algorithm (SOVA). The LDPC decoder 27 executes decoding processing (error detection/correction processing) of a low-density parity check code for a bit sequence decoded by the SOVA decoder 26.

Furthermore, the read channel 12R includes an ITIC controller 28, equalization waveform (EW) generator 29, and selector 30. The EW generator 29 generates equalization waveform data re-constructed according to the partial response maximum likelihood (PRML) method from NRZ data for respective sectors stored in the DRAM 16, as will be described later. The selector 30 selects and outputs equalization waveform data output from the EW generator 29 or that (FIR filter output data) stored in the DRAM 16 under the control of the ITIC controller 28.

In this embodiment, the ITIC controller 28 executes control of ITIC processing as a component included in the read channel 12R. Note that the ITIC controller 28 may be a function implemented by cooperation between the HDC 13 and MPU 14.

[Data Reproduction Operation]

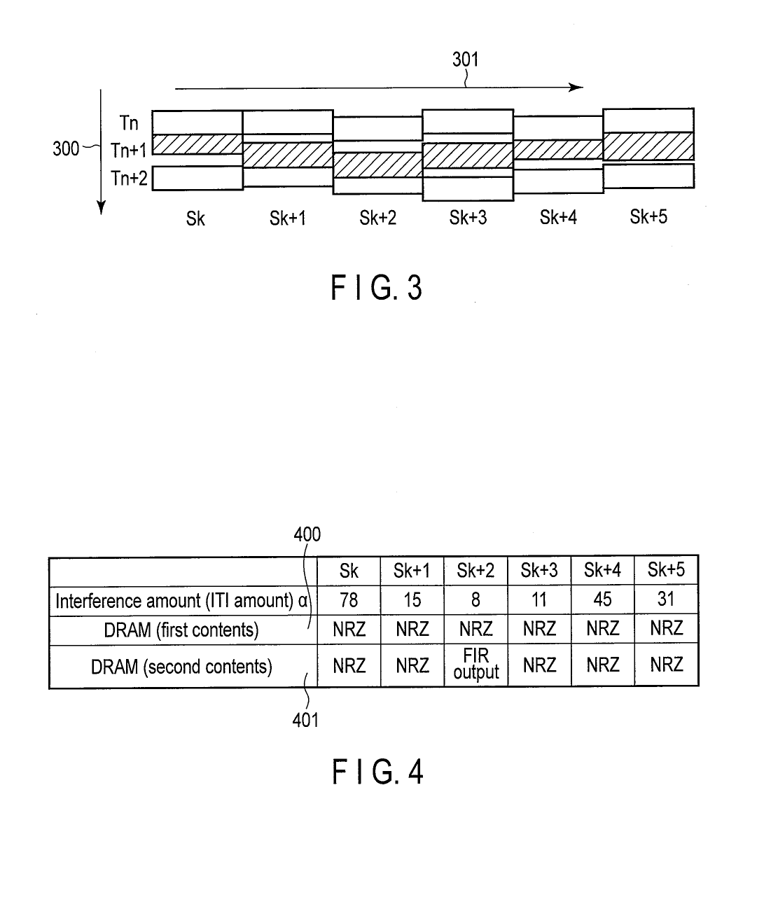

A data reproduction operation including ITI cancellation according to this embodiment will be described below with reference to FIGS. 3, 4, and 5.

Initially, as shown in FIG. 3, the disk drive of this embodiment continuously writes data to a plurality of tracks on the disk 1 in an overlapping state by the SMR operation in a data write operation mode. Note that data are written to three tracks, that is, a track Tn, track Tn+1, and track Tn+2 by the SMR operation for the sake of convenience. The data recorded on the respective tracks are managed while being divided into a plurality of sectors (a direction 301 indicates an order of sector numbers).

The disk drive executes a sequential read operation for sequentially reading data in a direction 300 from the track Tn to the track Tn+2 in a data reproduction operation mode. In this case, FIG. 3 expresses an example of a data recorded state written by the SMR operation on the track Tn+1 which neighbors the tracks Tn and Tn+2 by hatching. That is, when the sequential read operation for the track Tn+1 is executed, interference states (degrees of interference amounts) in sectors Sk to Sk+5 of the track Tn+1 with respect to the tracks Tn and Tn+2 can be estimated.

FIG. 4 shows an example of the estimated interference amounts. FIG. 4 indicates that interference amounts of sectors Sk and Sk+4 are large, and data (FIR filter output data) read from these sectors are strongly influenced by ITI from the adjacent track Tn. On the other hand, as shown in FIGS. 3 and 4, an interference amount especially in sector Sk+2 is very small, and ITI strongly influences the track Tn+2 in contrast to the track Tn+1.

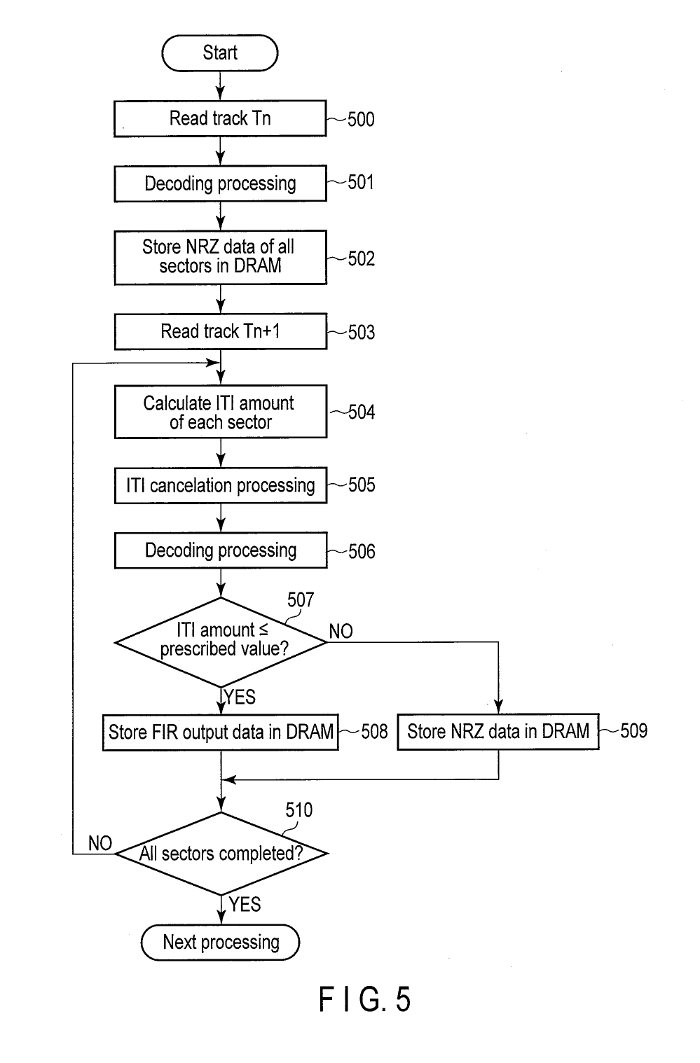

The ITI cancellation processing according to this embodiment and data storage processing in the DRAM 16 related to that processing will be described below with reference to the flowchart shown in FIG. 5.

Initially, in the disk drive, when a read error has occurred in a read operation mode, if a cause of the read error is ITI, the ITI cancellation of this embodiment is effective. More specifically, for example, in a read retry operation mode executed due to occurrence of the read error, the data reproduction operation including the ITI cancellation is effective. Therefore, in the read channel 12R of this embodiment, when no ITI cancellation is required, the functions of the ITI calculator 24 and ITI canceller 25 may be stopped.

In this embodiment, in the sequential read operation mode, the functions of the ITI calculator 24 and ITI canceller 25 are stopped for the first read target track Tn for the descriptive purpose. That is, when a read operation is started from the track Tn, the read channel 12R receives a read signal 100 transferred from the head amplifier IC 11 (block 500). The read signal 100 undergoes signal processing by the signal pre-processor including the AGC unit 20, LPF 21, and ADC 22, and the processed signal is sent to the FIR filter 23.

The FIR filter 23 outputs equalization waveform data (FIR output data) as an equalization waveform sequence of the read signal 100. In this case, the equalization waveform data from the FIR filter 23 is sent to the SOVA decoder 26 and LDPC decoder 27 while being passed through the ITI calculator 24 and ITI canceller 25. The SOVA decoder 26 and LDPC decoder 27 execute a series of decoding processes, and output NRZ data as decoded recorded data (block 501). The ITI controller 28 stores the NRZ data for all the sectors read from the read target track Tn in the DRAM 16 (block 502). That is, as shown in FIG. 4, storage contents 400 of the DRAM 16 include the NRZ data for all the sectors.

Next, when a sequential read operation for the track Tn+1 which neighbors the track Tn is started, the read channel 12R receives a read signal 100 corresponding to the read target track Tn+1 (block 503). In this case, the read channel 12R enables the functions of the ITI calculator 24 and ITI canceller 25 to execute the ITI cancellation (ITIC).

More specifically, the ITI calculator 24 calculates (estimates) a required cancel coefficient used in the ITIC for each sector based on equalization waveform data (track Tn+1) from the FIR filter 23 and that of the adjacent track Tn (block 504). That is, as shown in FIG. 4, the cancel coefficient corresponds to an average interference amount α (ITI amount) in sectors Sk to Sk+5 of the read target track Tn+1.

In this case, the ITIC controller 28 reads NRZ data corresponding to sectors Sk to Sk+5 of the adjacent track Tn from the DRAM 16 and inputs them to the EW generator 29. The EW generator 29 generates equalization waveform data re-constructed from the NRZ data. The selector 30 selects the equalization waveform data output from the EW generator 29 and outputs the selected data to the ITI calculator 24 under the control of the ITIC controller 28.

The ITI canceller 25 cancels ITI (signal interference or crosstalk) of the adjacent track Tn from the equalization waveform data output from the FIR filter 23 based on the cancel coefficient calculated (estimated) by the ITI calculator 24 (block 505). More specifically, the ITI canceller 25 executes the ITI cancellation using reference waveform data as a product of the cancel coefficient (interference amount α) and equalization waveform data output from the EW generator 29. After that, the SOVA decoder 26 and LDPC decoder 27 similarly execute a series of decoding processes, and output NRZ data as decoded recorded data (block 506).

The ITIC controller 28 stores the NRZ data of sectors Sk to Sk+5 of the read target track Tn+1 in the DRAM 16. In this case, the ITIC controller 28 determines interference amounts α (ITI amounts) in sectors Sk to Sk+5 of the read target track Tn+1, which are estimated by the ITI calculator 24 (block 507). The ITIC controller 28 determines sectors Sk to Sk+5 having interference amounts α (ITI amounts) which are not more than a prescribed value.

More specifically, the ITIC controller 28 determines that the interference amount α (ITI amount) of sector Sk+2 is not more than the prescribed value, as shown in FIG. 4, and stores equalization waveform data (FIR filter output data) as ITIC data for sector Sk+2 in the DRAM 16 (YES in block 507, block 508). When the interference amount α (ITI amount) is not more than the prescribed value, it is estimated that interference on the next read target track Tn+2 which neighbors the track Tn+1 is strong. That is, it is estimated that data of sector Sk+2 of the track Tn+1 is written while being displaced toward the corresponding sector side of the track Tn+2.

On the other hand, the ITIC controller 28 stores the NRZ data of sectors Sk to Sk+5 except for sector Sk+2 in the DRAM 16, and does not store equalization waveform data (FIR filter output data) corresponding to these sectors in the DRAM 16 (NO in block 507, block 509). That is, as shown in FIG. 4, storage contents 401 of the DRAM 16 include NRZ data except for sector Sk+2. Note that the NRZ data of sector Sk+2 is stored in the DRAM 16 independently of FIR data for ITI as data to be transferred to the host 18. The aforementioned processes (blocks 504 to 509) are repeated until they are completed for all sectors Sk to Sk+5 of the read target track Tn+1 (block 510).

As described above, upon execution of the sequential read operations for the tracks Tn, Tn+1, and Tn+2 recorded on the disk 1 by the SMR operation, the ITI cancellation of the read target track Tn+1 is executed based on correlations between the adjacent tracks Tn and Tn+1. In this case, upon execution of a read operation of the track Tn, the ITI cancellation function is disabled.

In this embodiment, when the ITI cancellation (ITIC) of the track Tn+1 is executed, interference amounts α (ITI amounts) in sectors Sk to Sk+5 are estimated, and a sector (sector Sk+2 in this case) having a large interference amount to the next read target track Tn+2 is estimated. As ITIC data for the next read target track, equalization waveform data (FIR filter output data) corresponding to sector Sk+2 is stored in the DRAM 16. That is, the DRAM 16 stores equalization waveform data corresponding to sector Sk+2 of the adjacent track Tn+1.

Therefore, upon execution of the sequential read operation for the next read target track Tn+2, the interference amount α (ITI amount) of sector Sk+2 is calculated (estimated) using the equalization waveform data (FIR filter output data) stored in the DRAM 16. In this way, an interference amount which seriously influences sector Sk+2 of the read target track Tn+2 can be calculated (estimated) with high precision. For this reason, the ITI cancellation for sector Sk+2 can be effectively executed. In this case, the ITI canceller 25 executes the ITI cancellation for sector Sk+2 of the read target track Tn+2 using reference waveform data as a product of the precisely calculated cancel coefficient (interference amount α) and the equalization waveform data stored in the DRAM 16.

Note that for each sector other than sector Sk+2 of the read target track Tn+2, an interference amount α (ITI amount) is calculated (estimated) using NRZ data stored in the DRAM 16 as ITIC data. In this case, since an interference amount α from each sector of the adjacent track Tn+1 is relatively small, the interference amount for each sector of the track Tn+2 can be calculated (estimated) with sufficiently high precision. Therefore, the ITI cancellation for the respective sectors except for sector Sk+2 can be sufficiently effectively executed. When an interference amount falls within an allowable range, the ITI cancellation is skipped as a matter of course.

That is, when it is estimated that the ITI influence is strong, it is desirable to store equalization waveform data (FIR filter output data) as ITIC data in the DRAM 16 in place of NRZ data. In this embodiment, as ITIC data of sector Sk+2 which is estimated to have a large interference amount on the next read target track Tn+2, equalization waveform data (FIR filter output data) is stored in the DRAM 16. Thus, the ITI cancellation can be effectively executed, thus improving the data reproduction performance.

On the other hand, as ITIC data for each of sectors except for sector Sk+2, which sectors are estimated to have a small interference amount, NRZ data is stored in the DRAM 16. Therefore, equalization waveform data (FIR filter output data) of all the sectors need not be stored in the DRAM 16 as ITIC data. For this reason, a large-capacity DRAM 16 need not be prepared. The DRAM 16 stores NRZ data of all sectors including sector Sk+2, but it stores equalization waveform data (FIR filter output data) as ITIC data only for some sectors. Therefore, the capacity of the DRAM 16 can be saved, and a decrease in use efficiency can be avoided. This makes it possible to implement effective ITI cancellation with high precision by efficiently using a buffer memory.

Note that when it is estimated that the ITI influence on the next read target track Tn+2 is considerably small, NRZ data need not be stored in the DRAM 16 as ITIC data for that sector (for example, sector Sk). As a matter of course, as data to be transferred to the host 18, NRZ data of sector Sk is also stored in the DRAM 16 in the same manner as that of the aforementioned sector Sk+2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A disk storage apparatus comprising:
a read controller configured to sequentially read data from tracks on a disk and to apply a waveform equalization processing to the read data;
a cancel controller configured to cancel an inter-track interference from an output from the read controller based on a correlation coefficient between waveform equalization data of a read target track and waveform equalization data of a track adjacent to the read target track;
a decoder configured to decode an output from the cancel controller;
a memory configured to store data used for calculating the correlation coefficient; and
a memory controller configured to store the output from the read controller in the memory when the correlation coefficient is lower than a predetermined value and to store the output from the decoder in the memory when the correlation coefficient is not lower than the predetermined value.

2. The disk storage apparatus of claim 1, wherein the cancel controller comprises:
a data generator configured to apply a waveform equalization processing to data read from the memory to generate the waveform equalization signal of the track adjacent to the read target track.

3. The disk storage apparatus of claim 2, wherein the cancel controller comprises:
a calculator configured to calculate the correlation coefficient using the output from the read controller and one of the output from the decoder read from the memory and an output from the data generator.

4. The disk storage apparatus of claim 1, wherein each of the tracks comprises data areas,
the decoder is configured to respectively decode data for the data areas,
the cancel controller is configured to respectively cancel the inter-track interference for the data areas, and
the memory controller is configured to respectively store the output from the read controller or the output from the decoder for the data areas.

5. A data reproduction apparatus comprising:
a cancel controller configured to cancel an inter-track interference from equalization waveform data of a read signal of a read target track based on a correlation coefficient between the waveform equalization data of the read target track and waveform equalization data of a track adjacent to the read target track;
a decoder configured to decode an output from the cancel controller; and
a memory controller configured to store the waveform equalization data of the read target track in a memory when the correlation coefficient is lower than a predetermined value and to store the output from the decoder in a memory when the correlation coefficient is not lower than the predetermined value, wherein data stored in the memory is used to calculate the correlation coefficient.

6. The data reproduction apparatus of claim 5, wherein the cancel controller comprises:
a data generator configured to apply a waveform equalization processing to data read from the memory to generate the waveform equalization signal of the track adjacent to the read target track.

7. The data reproduction apparatus of claim 6, wherein the cancel controller comprises:
a calculator configured to calculate the correlation coefficient using the output from the read controller and one of the output from the decoder read from the memory and an output from the data generator.

8. The data reproduction apparatus of claim 5, wherein
the decoder is configured to decode an output from the cancel controller for respective data areas,
the cancel controller is configured to cancel the inter-track interference for the respective data areas, and
the memory controller is configured to store the waveform equalization data of the read target track or the output from the decoder in the memory for the respective data areas.

9-12. (canceled)

13. A method of reproducing data in a data storage apparatus, which sequentially reads data from tracks on a disk, the method comprising:
generating waveform equalization data by applying waveform equalization processing to a read signal;
calculating a correlation coefficient between waveform equalization data of a read target track and waveform equalization data of the track adjacent to the read target track;
canceling an inter-track interference from the waveform equalization data of the read target track based on the correlation coefficient;
decoding the inter-track interference cancelled waveform equalization data;
and
storing the generated waveform equalization data in a memory when the correlation coefficient is lower than a predetermined value, wherein data stored in the memory is used to calculate the correlation coefficient.

14. The method of claim 13, further comprising:
storing the decoded and inter-track interference cancelled waveform equalization data in the memory when the correlation coefficient is not lower than the predetermined value.

15. The method of claim 13, further comprising:
applying a waveform equalization processing to data read from the memory to generate the waveform equalization signal of the track adjacent to the read target track.

16. The method of claim 15, further comprising:
calculating the correlation coefficient using the waveform equalization data of the read target track and one of the generated waveform equalization data read from the memory and the generated waveform equalization data of the track adjacent to the read target track.

17. The method of claim 13, wherein each track includes data areas, and the decoding, the cancelling, and the storing are executed for respective data areas.
